(19) United States
(12) Patent Application Publication
(10) Pub. No.: US 2025/0023260 A1
(43) Pub. Date: Jan. 16, 2025

(54) BATTERY TERMINAL CLAMP ASSEMBLY WITH IMPROVED SECUREMENT AND METHOD OF FORMING THE SAME

(71) Applicant: EATON INTELLIGENT POWER LIMITED, Dublin 4 (IE)

(72) Inventors: Nathan Hollin, West Chicago, IL (US); Steve Krass, Saint Charles, IL (US); Douglas John Robbins, Lake in the Hills, IL (US)

(21) Appl. No.: 18/711,819

(22) PCT Filed: Dec. 14, 2022
(86) PCT No.: PCT/EP2022/025574

§ 371 Date: May 20, 2024

Related U.S. Application Data
(60) Provisional application No. 63/289,627, filed on Dec. 14, 2021.

(51) Int. Cl. H01R 11/28

(52) U.S. Cl. CPC H01R 11/283

(57) ABSTRACT

A vehicle battery terminal clamp assembly features a clasping mechanism and a securement assembly. The clasping mechanism includes a top wall with an upper battery post aperture and an upper slit, a bottom wall with a lower battery post aperture and a lower slit, and a front wall integrally extending between the top and bottom walls and including a front slit, and wherein the upper slit, the lower slit, and the front slit are arranged to form a continuous slit that extends from the upper battery post aperture, across the front wall and to the lower battery post aperture. The upper and lower battery post apertures are configured to receive an extent of a post extending from the vehicle battery. The securement assembly applies less than a nominal compressive force on the clasping mechanism, wherein the top wall of the clasping mechanism is substantially parallel with the bottom wall of the clasping mechanism. In contrast, when the securement assembly applies a sufficient compressive force on the clasping mechanism, the top wall of the clasping mechanism is not substantially parallel with the bottom wall of the clasping mechanism which increases the “pull-off force” of the inventive battery terminal clamp assembly.

### RELATED APPLICATIONS

This application claims the benefit from U.S. provisional patent application No. 63/289,627, which was filed on Dec. 14, 2021, and are incorporated herein by this reference.

### FIELD OF DISCLOSURE

The present disclosure relates to an electrical connector, more specifically a battery terminal clamp assembly having a clasping mechanism and a securement assembly. When the battery terminal clamp is secured to a post of a vehicle battery, the securement assembly is in an installed state where a bottom wall assembly of the clamping assembly is separated from a lower wall assembly of the clamping assembly. In the installed state, the force required to pull-off and remove the inventive terminal clamp from the battery post is increased over conventional battery terminal clamps. Additionally, the inventive battery terminal clamp reduces the amount of scrap material generated during the manufacturing process, as compared to conventional battery terminal clamps which reduces material costs while increasing the value of the inventive terminal clamp.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for various reasons, including but not limited to monitoring, improving and/or controlling the vehicle's performance, emissions, safety and interior cabin environment for the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies that interconnect these components due to a number of conditions, including but not limited to, space constraints that make initial installation difficult, harsh operating conditions, large ambient temperature ranges, prolonged vibration, heat loads, and longevity, all of which can lead to premature component and/or connector performance degradation or failure. For example, incorrectly installed battery terminal connectors or “clamps”, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all automotive manufacturers and their direct suppliers is estimated to be between $50 billion and $150 billion, worldwide. In light of these challenging electrical environments, considerable time, money, and energy have been expended to develop and manufacture power distribution components that meet the varied needs of the vehicles and their markets. This disclosure addresses the shortcomings of conventional power distribution components. A full discussion of the features and advantages of the present disclosure is deferred to the following detailed description, which proceeds with reference to the accompanying drawings.

### BRIEF DESCRIPTION OF THE DRAWINGS

FIG. 1 is a perspective view of a conventional battery terminal clamp assembly in an assembled state S_{A} and having a conventional clasping mechanism and a securement assembly;

FIG. 2 is a top view of a piece of sheet metal stock having outlines of two conventional clasping mechanism blanks in an unfolded state Su, and wherein said blanks are subjected to a forming process that includes multiple folding steps to form the conventional clasping mechanism of FIG. 1;

FIGS. 3A-3H show eight steps in the forming process to move one of the clasping mechanism blanks of FIG. 2 from the unfolded state Su to a folded state S_{F};

FIG. 4 is a top view of the conventional battery terminal clamp assembly of FIG. 1 positioned around an extent of a battery post of a battery and in an installed state S_{I};

FIG. 5 is a cross-sectional view of the conventional battery terminal clamp assembly taken along line 5-5 of FIG. 4;

FIG. 6 is a perspective view of a first embodiment of an inventive battery terminal clamp assembly in an assembled state S_{A} and having a clasping mechanism and a securement assembly;

FIG. 7 is a front view of the battery terminal clamp assembly of FIG. 6;

FIG. 8 is a top view of the battery terminal clamp assembly of FIG. 6;

FIG. 9 is an exploded view of the battery terminal clamp assembly of FIG. 6;

FIGS. 10A-10C is a top view of a piece of sheet metal stock having outlines of two clasping mechanism blanks in an unfolded state Su, and wherein said blanks are subjected to a forming process that includes multiple folding steps to form the clasping mechanism of FIG. 6;

FIGS. 11A-11G show seven steps in the forming process to move one of the clasping mechanism blanks of FIG. 10 from the unfolded state Su to a folded state S_{F};

FIG. 12 is a top view of the battery terminal clamp assembly of FIG. 6 in a disassembled state S_{D}, and wherein an extent of the securement assembly is omitted;

FIG. 13 is a cross-sectional view of the battery terminal clamp assembly taken along line 13-13 of FIG. 12;

FIG. 14 is a cross-sectional view of the battery terminal clamp assembly taken along line 13-13 of FIG. 12, and wherein the battery terminal clamp assembly is in a first partially assembled state S_{1P};

FIG. 15 is a cross-sectional view of the battery terminal clamp assembly taken along line 13-13 of FIG. 12, and wherein the battery terminal clamp assembly is in a second partially assembled state S_{2P};

FIG. 16 is a cross-sectional view of the battery terminal clamp assembly taken along line 13-13 of FIG. 12, and wherein the battery terminal assembly is in a third partially assembled state S_{3P};

FIG. 17 is a side view of the battery terminal clamp assembly of FIG. 6 positioned around an extent of a battery post of a battery and in a partially installed state S_{PI};

FIG. 18 is a cross-sectional view of the battery terminal clamp assembly taken along line 18-18 of FIG. 17;

FIG. 19 is a top view of the battery terminal clamp assembly of FIG. 6 positioned around an extent of a battery post of a battery and in the partially installed state S_{PI};

FIG. 20 is a cross-sectional view of the battery terminal clamp assembly taken along line 20-20 of FIG. 19;

FIG. 21 is a side view of the battery terminal clamp assembly of FIG. 6 positioned around an extent of a battery post of a battery and in an installed state S_{I};

FIG. 22 is a cross-sectional view of the battery terminal clamp assembly taken along line 22-22 of FIG. 21;

FIG. 23 is a top view of the battery terminal clamp assembly of FIG. 6 positioned around an extent of a battery post of a battery and in an installed state S_{I};

FIG. 24 is a cross-sectional view of the battery terminal clamp assembly taken along line 24-24 of FIG. 23;

FIG. 25 is a perspective view of a second embodiment of an inventive battery terminal clamp assembly in an assembled state S_{A} and having a clasping mechanism and a securement assembly;

FIG. 26 is a top view of a piece of sheet metal stock having outlines of two clasping mechanism blanks in an unfolded state Su, and wherein said blanks are subjected to a forming process that includes multiple folding steps to form the clasping mechanism of FIG. 25;

FIGS. 27A-27F shows six steps in the forming process to move one of the clasping mechanism blanks of FIG. 26 from the unfolded state Su to a folded state S_{F};

FIG. 28 is a top view of the battery terminal clamp assembly of FIG. 25 positioned around an extent of a battery post of a battery and in a partially installed state S_{PI};

FIG. 29 is a cross-sectional view of the battery terminal clamp assembly taken along line 29-29 of FIG. 28;

FIG. 30 is a top view of the battery terminal clamp assembly of FIG. 25 positioned around an extent of a battery post of a battery and in an installed state S_{I}; and

FIG. 31 is a cross-sectional view of the battery terminal assembly taken along line 31-31 of FIG. 30.

### DETAILED DESCRIPTION

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

The inventive battery terminal clamp assembly 510 is designed to fit over an elongated battery terminal post 5, for example, a post with a frustoconical shape, to couple a vehicle battery 7 to a cable and provide several benefits over a conventional battery terminal clamp assembly 10. Even though the inventive battery terminal clamp assembly 510 may be heavier than the conventional battery terminal clamp assembly 10, the formation of the inventive battery terminal clamp assembly 510 reduces material waste compared to the formation of the conventional battery terminal clamp assembly 10. The inventive clasping mechanism 600 reduces material waste by more than 35%. Additionally, when the inventive battery terminal clamp assembly 510 and conventional battery terminal clamp assembly 10 are placed on similar battery post 5 and the securement assemblies 300, 800 are torqued to the same value, the inventive battery terminal clamp assembly 510 has a pull-off force that: (i) exceeds current USCAR specifications and (ii) is more than 40% greater than the pull-off force associated with the conventional battery terminal clamp assembly 10.

A second version of the inventive battery terminal clamp assembly 1510 is designed to fit over the battery terminal post 5 to couple a vehicle battery 7 to a cable and provide several benefits over a conventional battery terminal clamp assembly 10. Even though the inventive battery terminal clamp assembly 1510 may be heavier than the conventional battery terminal clamp assembly 10, the formation of the inventive battery terminal clamp assembly 1510 reduces material waste compared to the formation of conventional battery terminal clamp assembly 10. The inventive clasping mechanism 1600 reduces material waste by more than 35%. Additionally, when the inventive battery terminal clamp assembly 1510 and conventional battery terminal clamp assembly 10 are placed on similar battery post 5 and the securement assemblies 300, 1300 are torqued to the same value, the inventive battery terminal clamp assembly 1510 has a pull-off force that: (i) exceeds current USCAR specifications and (ii) is more than 30% greater than the pull-off force associated with the conventional battery terminal clamp assembly 10.

### Conventional Battery Terminal Clamp Assembly

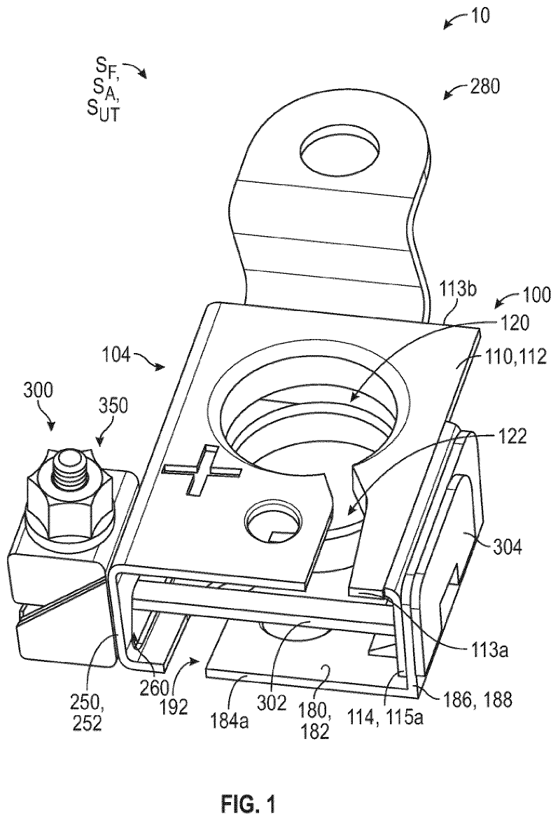

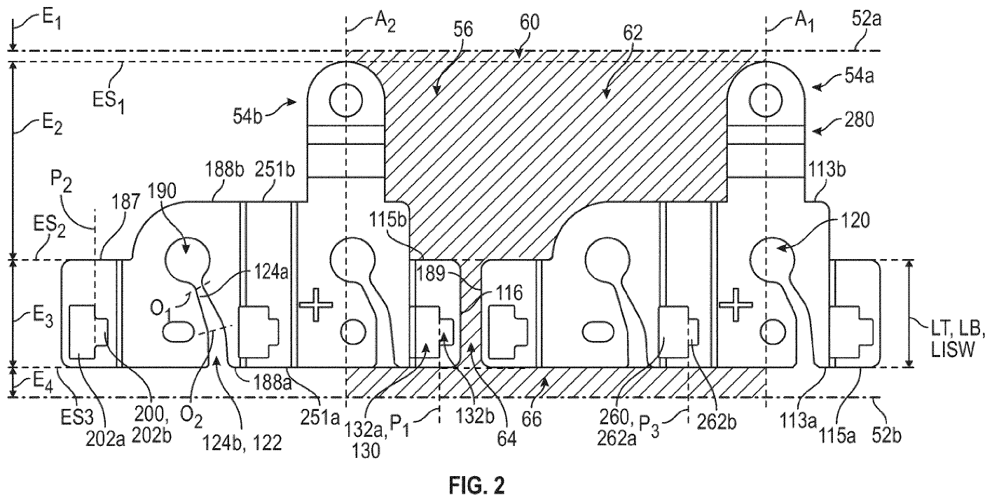

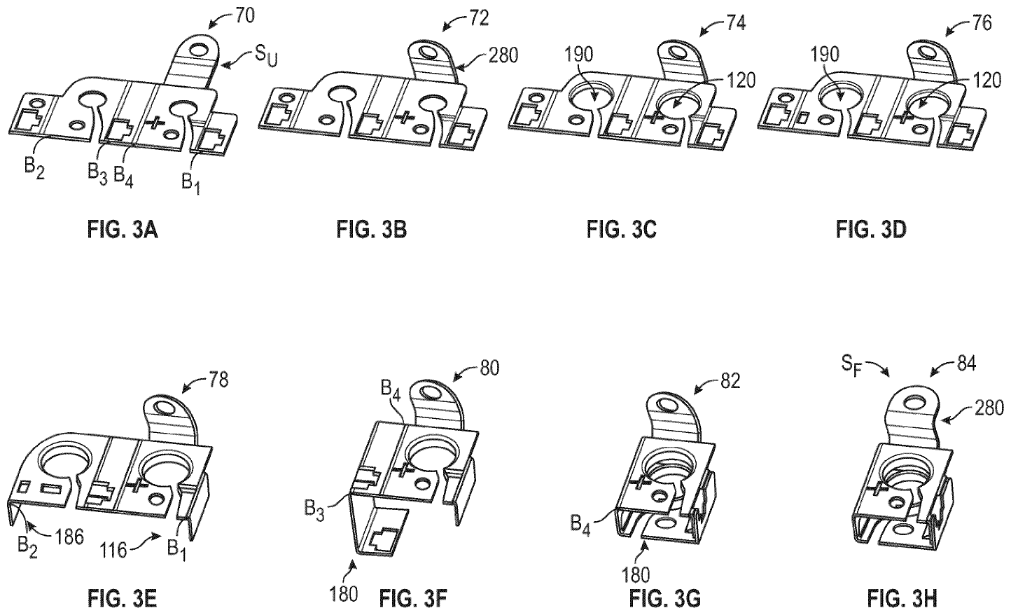

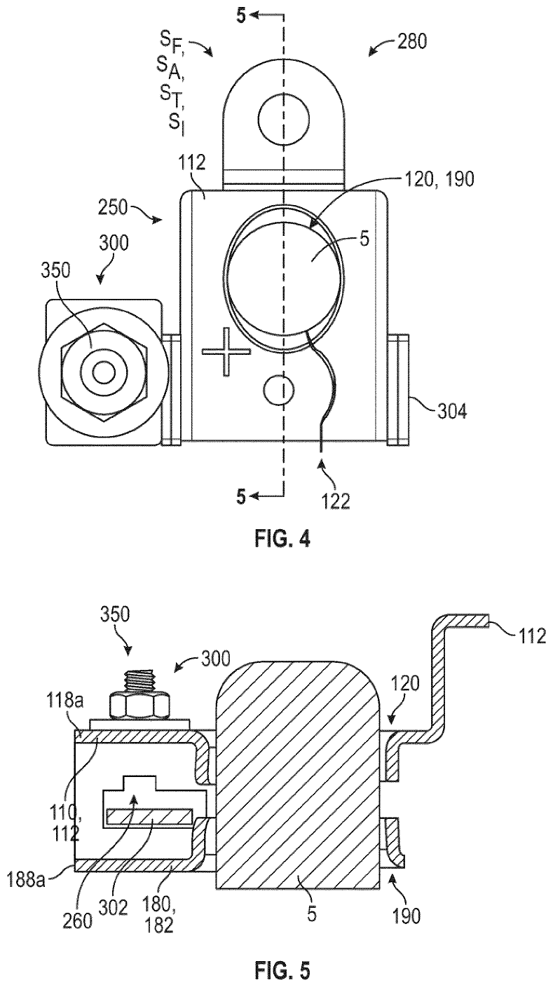

FIGS. 1-5 show a conventional battery terminal clamp assembly 10 in various stages of assembly and use. In particular, FIG. 1 shows the conventional battery terminal clamp assembly 10 in an assembled state S_{A}, FIGS. 2A-3 show the formation process of the conventional clasping mechanism 100, and FIG. 4 shows the conventional battery terminal clamp assembly 10 in an installed or ready-to-use state. Referring to FIG. 1, the conventional battery terminal clamp assembly 10 comprises a conventional clasping mechanism 100 and a securement assembly 300. The conventional clasping mechanism 100 includes a body 104 and an attachment assembly 280.

a. Clasping Mechanism

The attachment assembly 280 extends from an extent of the body 104 and is configured to electrically couple the body 104 to an external device, component, or part. In this conventional clasping mechanism 100, the attachment assembly 280 includes an arrangement of walls bent relative to one another and an aperture 282 configured to receive an elongated battery cable fastener (not shown).

The body 104 has a top wall arrangement 110, a bottom wall arrangement 180, and an intermediate side wall 250. The top wall arrangement 110 includes: (i) an upper wall 112 with a front surface 113a and a rear surface 113b, and (ii) a top or first side wall 114 with a front surface 115a and a rear surface 115b. The upper wall 112 includes: (i) an upper battery post aperture 120 that is configured to receive a battery post 5 (e.g., may be any post size (JIS, DIN, SAE, IEC)), and (ii) an upper gap 122, which is configured to shrink when the securement assembly 300 moves from an untightened state S_{UT} to a tightened state S_{T}. To allow for said shrinkage, the upper gap 122 extends from the upper battery post aperture 120 to the front surface 113a of the upper wall 112, and includes two substantially linear sections. The first upper substantially linear section 124a extends from the upper battery post aperture 120 to an apex 126, and the second upper substantially linear section 124b extends from the apex 126 to the front surface 113a of the upper wall 112. As described above, each sections 124a, 124b of the upper gap 122 is substantially linear and is not curvilinear. Additionally, the upper gap 122 only includes two sections 124a, 124b and does not include more than two sections (e.g., three sections).

The first side wall 114 is integrally formed with the upper wall 112 and the front surface 115a is substantially co-planar with the front surface 113a of the upper wall 112. To integrally form the first side wall 114 with the upper wall 112, the first side wall 114 is formed from the same piece of sheet metal stock 50 and is bent along bend line B₁. When the first side wall 114 is bent into position, it: (i) extends downward from the upper wall 112, (ii) extends towards the bottom wall arrangement 180, and (iii) is configured to be perpendicular to the upper wall 112. A first pull bar opening 130 is formed in the first side wall 114 and includes two rectangular extents. The first rectangular extent 132a of the first pull bar opening 130 extends from an edge that is positioned adjacent to the upper wall 112 to the pull bar opening line P₁, and the second rectangular extent 132b of the first pull bar opening 130 extends from the pull bar opening line P₁ to an edge that is positioned near the lower edge 116 of the first side wall 114.

The intermediate side wall 250 of the body 104 has a front surface 252 and is integrally formed with the upper and lower walls 112, 182. Additionally, the intermediate side wall 250 is configured to be positioned: (i) opposite of the first and second side walls 114, 186, and (ii) substantially perpendicular to the upper and lower walls 112, 182. To integrally form the intermediate side wall 250 with the upper and lower walls 112, 182, the intermediate side wall 250 is formed from the same piece of sheet metal stock 50 and is bent along bend lines B₃, B₄. As shown in FIG. 2, the bend lines B₃, B₄ extend along the entire length of the intermediate side wall 250 (extending between front edge 251a and rear edge 251b) and are positioned substantially perpendicular to the front surfaces 113a, 184 of the upper and lower walls 112, 182. The intermediate side wall 250 has a length L_{ISW}: (i) substantially equal to the length L_{T} of the upper wall 112, which extends between front surface 113a and rear surface 113b, and (ii) substantially equal to an extent of the length L_{B} of the lower wall 182, which extends between front surface 188a and rear surface 188b. As such, the length of the bend lines B₃, B₄ is substantially equal to the length L_{T} of the upper wall 112, and substantially equal to an extent of the length L_{B} of the lower wall 182. Additionally, from the above description and the Figures, it should be understood that the intermediate side wall 250 and the first side wall 114 are positioned on opposite sides of the top wall 612. However, said side walls 114, 250 do not mirror one another. In other words, the configuration of the outer periphery of the side walls 114, 250 are not the same.

The intermediate side wall 250 includes a third pull bar opening 260 with two rectangular extents. The first rectangular extent 262a of the third pull bar opening 260 extends from an edge that is positioned adjacent the lower wall 182 to a pull bar opening line P₃, and the second rectangular extent 262b of the third pull bar opening 260 extends from the pull bar opening line P₃ to an edge that is positioned near to the upper wall 112. The configuration of the third pull bar opening 260 is the same as the configuration of the first and second pull bar openings 130, 200. As such, all three pull bar openings 130, 200, 260 include two extents 132a, 132b, 202a, 202b, 262a, 262b, wherein the configuration of the first extents 132a, 202a, 262a match each other and the configuration of the second extents 132b, 202b, 262b match each other. As best shown in FIGS. 1 and 5, the body 104 does not include a front wall that couples the front surface 113a of the upper wall 112 to the front surface 184 of the lower wall 182. Instead, and as discussed above, the upper wall 112 is coupled to the lower wall 182 via the intermediate side wall 250. Because the body 104 lacks a front wall, said body 104 does not include an opening formed in an extent of the front wall. Also, due to the inclusion of the intermediate side wall 250, the body 104 lacks four side walls. In other words, the top wall arrangement 110 and the bottom wall arrangement 180 only include a single side wall 114, 186.

The bottom wall arrangement 180 includes: (i) a lower wall 182 with a front surface 184, and (ii) a bottom or second side wall 186 with a rear edge 187. The lower wall 182 includes: (i) a lower battery post aperture 190 that is configured to receive a battery post 5, and (ii) a lower gap 192, which is configured to shrink when the securement assembly 300 moves from an untightened state S_{UT} to a tightened state S_{T}. To allow for said shrinkage, the lower gap 192 extends from the lower battery post aperture 190 to the front surface 184 of the lower wall 182, and includes two substantially linear sections. The first lower substantially linear section 194a extends from the lower battery post aperture 190 to an apex 196, and the second lower substantially linear section 194b extends from the apex 196 to front surface 184 of the lower wall 182. As described above, each section 194a, 194b of the lower gap 192 is substantially linear and is not curvilinear. Additionally, the lower gap 192 only includes two sections 194a, 194b and does not include more than two sections (e.g., three sections).

The second side wall 186 is integrally formed with the lower wall 182 and the front surface 188a is substantially co-planar with the front surface 184 of the lower wall 182. To integrally form second side wall 186 with the lower wall 182, the second side wall 186 is formed from the same piece of sheet metal stock 50 and is bent along bend line B₂. When the second side wall 186 is bent into position, it: (i) extends upward from the lower wall 182, (ii) extends towards the top wall arrangement 110, and (iii) is configured to be perpendicular to the lower wall 182. A second pull bar opening 200 is formed in the second side wall 186 and includes two rectangular extents. The first rectangular extent 202a of the second pull bar opening 200 extends from an edge that is positioned near the upper edge 187 of the second side wall 186 to a pull bar opening line P₂, and the second rectangular extent 202b of the second pull bar opening 200 extends from the pull bar opening line P₂ to an edge that is positioned near to the lower wall 182.

b. Securement Assembly

The securement assembly 300 includes a pull bar 302, and a clamping assembly 350. The pull bar 302 has a first end 304 configured to be positioned adjacent to the bottom side wall 186, an intermediate extent that is positioned within the pull bar openings 130, 200, 260, and an end extent that is coupled to the clamping assembly 350. Said clamping assembly 350 is configured to be positioned adjacent to the intermediate side wall 250 and has two terminal states. The first state is an untightened state S_{UT}, where the securement assembly 300 does not apply a sufficient compressive force or applies only a nominal compressive force on the conventional clasping mechanism 100. The second state is a tightened state S_{T}, where the securement assembly 300 has been torqued to a set value (e.g., between 7.5 and 10.5 Nm, and preferably 9 Nm) and applies a sufficient compression or compressive sufficient force on the conventional clasping mechanism 100 causing it to respond as detailed in the following paragraph. Thus, the sufficient compressive force is appreciably greater than a nominal force that does not result in compression of the clasping mechanism 100. In this tightened state S_{T}, the compression force on the conventional clasping mechanism 100 generates a clamping force Fc on the battery post 5 and causes: (i) the upper gap 122 to shrink from its original state (FIG. 1) to a shrunken state (FIG. 4), (iii) the lower gap 192 to shrink from its original state to a shrunken state, and (iv) the width of the battery post apertures 120, 190 is reduced from their original state (FIG. 1) to a reduced state (FIG. 4). Additional disclosure about the operation and functionality of the securement assembly 300 is disclosed in detail in U.S. Pat. No. 10,008,789, which is hereby incorporated by reference.

FIG. 2 shows a substantially planar piece of sheet metal stock 50 having: (i) a top edge 52a, (ii) a bottom edge 52b, and (iii) outlines of two conventional clasping mechanism blanks 54a-54b positioned between the top and bottom edges 52a-52b. Positioned on the sheet metal stock 50 and between the conventional clasping mechanism blanks 54a-54b is an extent of scrap or engineered scrap 56 due to the configuration of the conventional clasping mechanism 100. This engineered scrap 56 is an extent of the metal stock 50 that cannot be used due to the configuration of the blanks 54a-54b and the spacing needed to cut said blanks 54a-54b from the stock 50. Specifically, the engineered scrap 56 includes four extents 60, 62, 64, and 66. The first extent 60 of engineered scrap 56 has a first area A₁ that extends between: (i) a first axis A₁ that extends through the center of an aperture 282a that is configured to receive an elongated battery cable fastener, (ii) a second axis A₂ that extends through an aperture 282b that is configured to receive an elongated battery cable fastener, (iii) the top edge of the blank 52a, and (iv) a first engineered scrap line ES₁ that is aligned with an uppermost extent of the attachment assembly 280. The second extent 62 of engineered scrap 56 has a second area A₂ that extends between: (i) the left edge of the first conventional clasping mechanism blank 54a, namely comprised of edges associated with the attachment assembly 280, the upper wall 112, the intermediate side wall 250, the lower wall 182, and second side wall 186, (ii) the right edge of the second conventional clasping mechanism blank 54b, namely comprised of edges associated with the attachment assembly 280, the upper wall 112, and first side wall 114, (iii) the first engineered scrap line ES₁, and (iv) a second engineered scrap line ES₂ that is aligned with the rear edges of the 115b, 187 of the first and second side walls 114, 186.

The third extent 64 of engineered scrap 56 has a third area A₃ that extends between: (i) an upper edge 189 of the second side wall 186, (ii) a lower edge 119 of the first side wall 114, (iii) the first engineered scrap line ES₂, and (iv) a third engineered scrap line ES₃ that is aligned with the front surfaces 113a, 184 of the first and second side walls 114, 186. The fourth extent 66 of engineered scrap 56 has a fourth area A₄ that extends between: (i) the first axis A₁, (ii) the second axis A₂, (iii) bottom edge of the blank 52b, and (iv) the third engineered scrap line ES₃. As such, the engineered scrap 56 has an area A_{ES} equal to the sum of the first through the fourth areas A₁-A₄. In other words, the engineered scrap 56 has an area A_{ES} that substantially extends between: (i) the first axis A₁, (ii) the second axis A₂, (iii) the left edge of the first conventional clasping mechanism blank 54a, (iv) the right edge of the second conventional clasping mechanism blank 54b, (v) top edge of the blank 52a, and (iv) the bottom edge of the blank 52b.

Once one of the conventional clasping mechanism blanks 54a-54b is removed from the sheet metal 50, each blank 54a-54b undergoes a process that converts said blank 54a-54b from an unfolded state Su to a folded state S_{F}. This eight-step process is shown in FIGS. 3A-3H, wherein step 1 (70) is the step of acquiring the blank 54a, step 2 (72) includes bending an extent of the attachment assembly 280, steps 3 and 4 (74, 76) form the upper and lower battery post apertures 120, 192, step 5 (78) forms the top and bottom side walls 114, 186, step 6 (80) places the lower wall 182 perpendicular to the upper wall 112, step 7 (82) moves the lower wall 182 from its perpendicular arrangement with the upper wall 112 in step 6 to substantially parallel with the upper wall 112, and step 8 (84) finishes bending the attachment assembly 280 in another direction. Reducing the number of steps needed to convert each blank 54a-54b from the unfolded state Su to the folded state S_{F} is desired because it makes the conventional battery terminal clamp assembly 10 less expensive to manufacture.

FIGS. 4-5 show the conventional battery terminal clamp assembly 10 in an installed state S_{I}. Said installed state S_{I} occurs after: (i) the conventional battery terminal clamp blank 54a-54b is removed from the sheet metal 50, (ii) said blank 54a-54b undergoes a process that converts the blank 54a-54b from an unfolded state Su to a folded state S_{F}, (iii) a securement assembly 300 has been coupled to the conventional clasping mechanism 100 to form an assembled state S_{A}, (iv) the battery post 5 is positioned in the battery post apertures 120, 190, and (v) the securement assembly 300 moves from the untightened state S_{UT} to the tightened state S_{T}. By placing the securement assembly 300 in said tightened state S_{T}, the conventional battery terminal clamp assembly 10 applies a clamping force Fc on the battery post 5. When the clamping force Fc is applied to said battery post 5: (i) the top and bottom walls 114, 182 remain substantially parallel to one another, (ii) the upper gap 122 shrinks from its original state to a shrunken state, (iii) the lower gap 192 shrinks from its original state to a shrunken state, and (iv) the width of the battery post apertures 120, 190 is reduced from their original state to a reduced state. The above described reductions, do not substantially alter the distance separating the upper wall 112 and the lower wall 182. In other words: (i) prior to installment on a battery post 5, a pre-install distance extends between the lower surface of the upper wall 112 and the upper surface of the lower wall 182, and (ii) after installment on a battery post 5, an installed distance extends between the lower surface of the upper wall 112 and the upper surface of the lower wall 182, and wherein the installed distance is substantially equal to the pre-install distance. Stated another way, the conventional battery terminal clamp assembly 10 does not have the spreading effect that is disclosed in connection with the inventive assemblies 510, 1510 disclosed here. In light of the lack of a spreading effect, when the conventional battery terminal clamp assembly 10 is placed on a battery post 5 and the securement assembly 300 is torqued to a first value (e.g., between 7.6 and 10.4 Nm, and preferably 9 Nm), the conventional battery terminal clamp assembly 10 has a pull-off of more than 980 N, and preferably approximately 2,000 N.

### First Embodiment—Inventive Battery Terminal Clamp Assembly

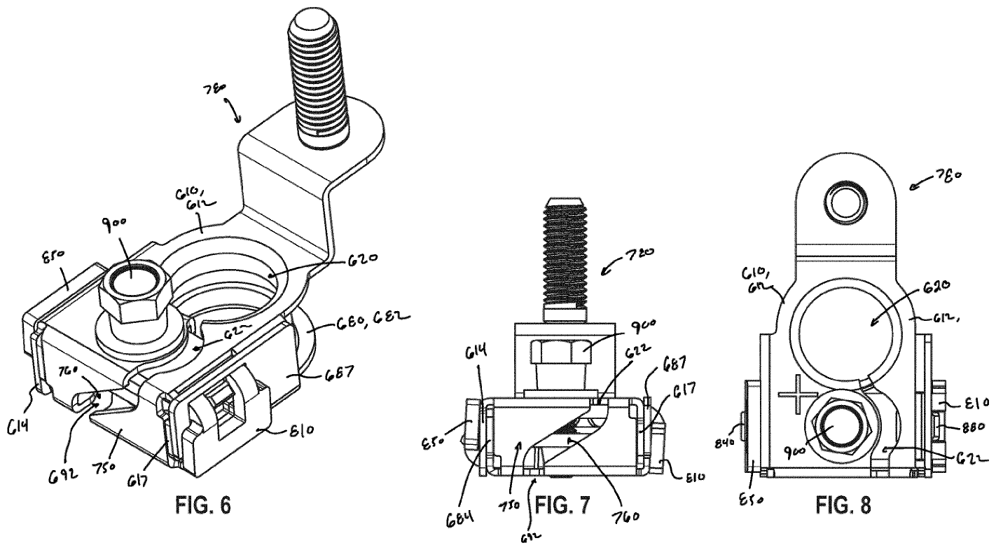

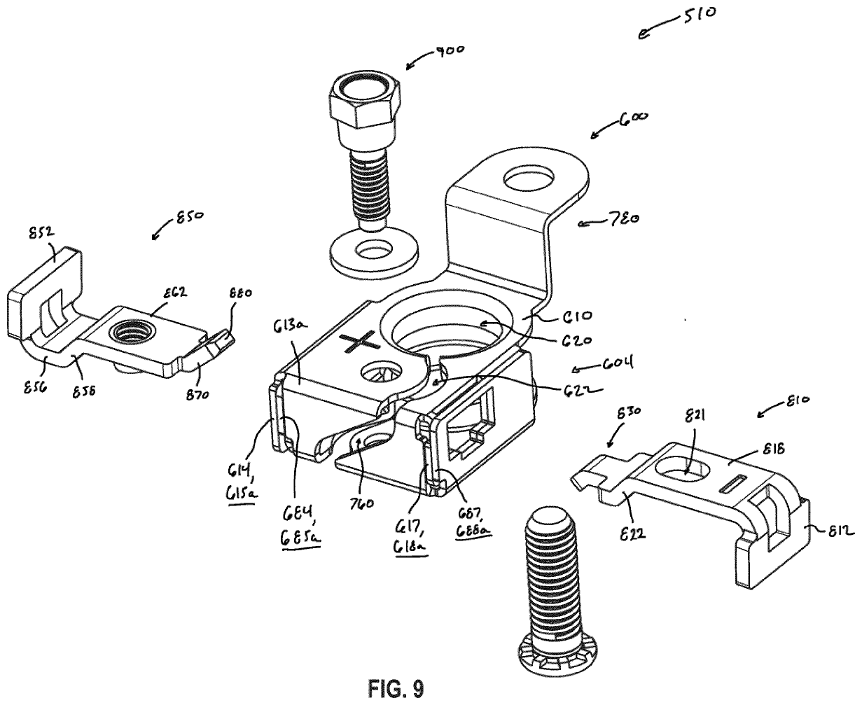

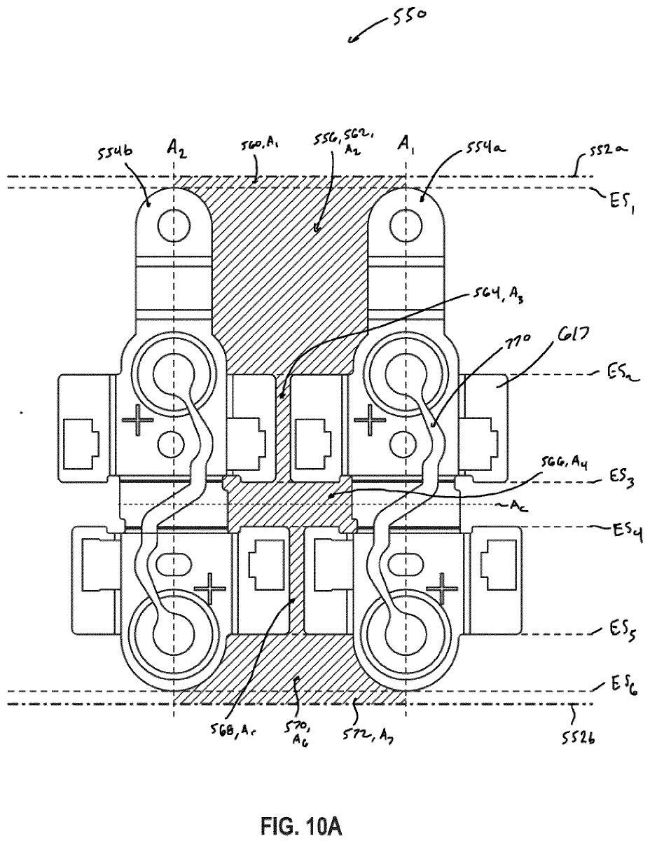

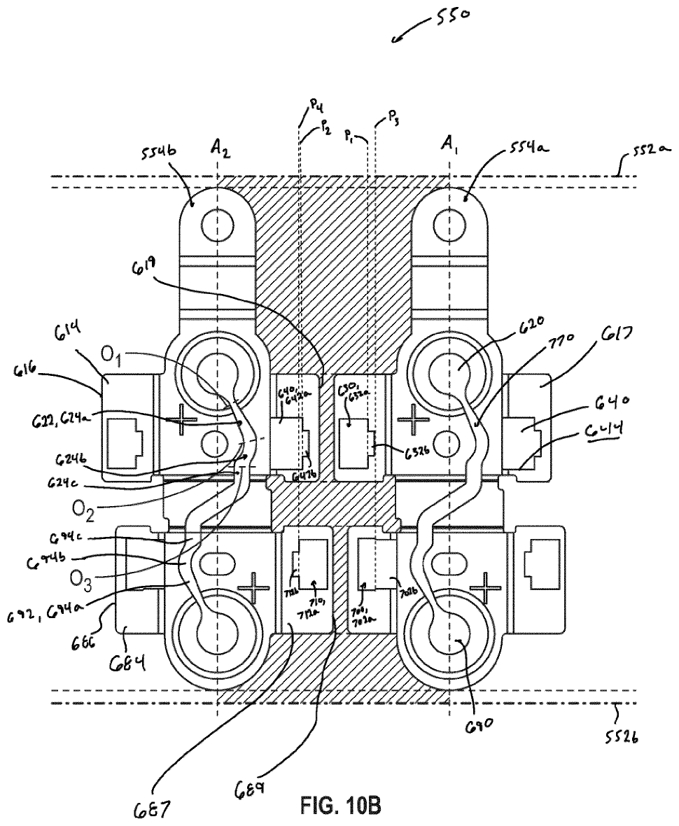

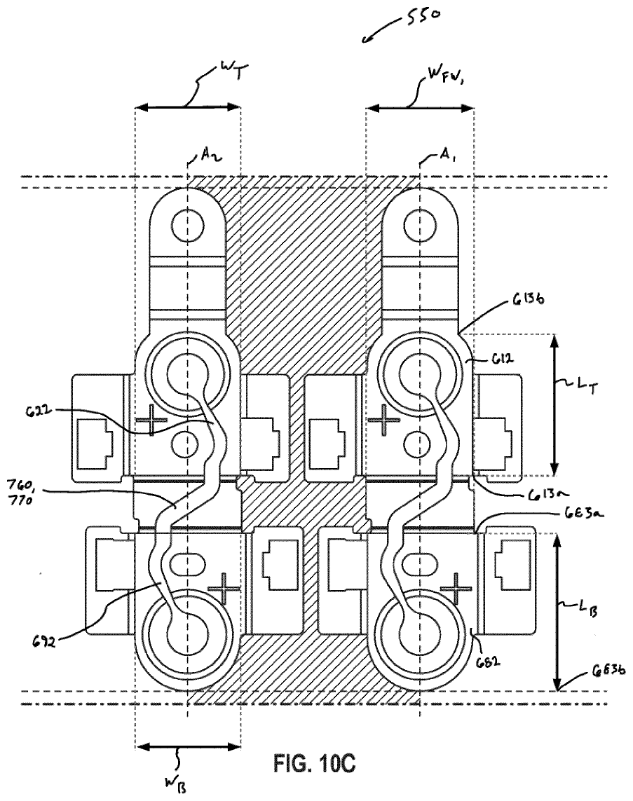

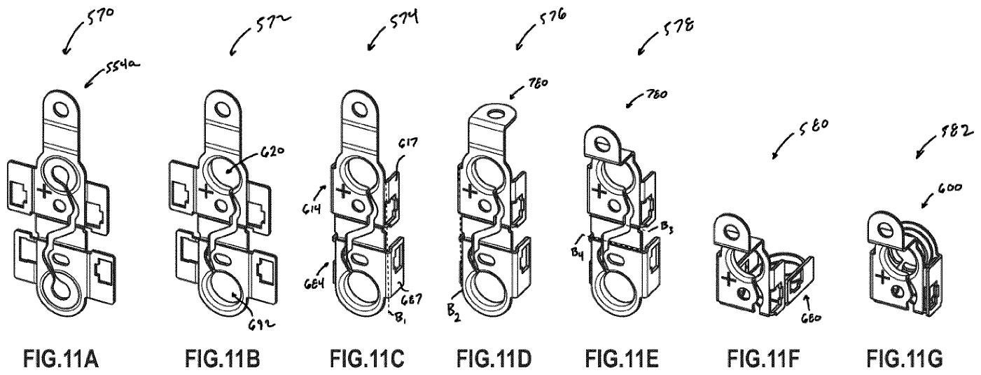

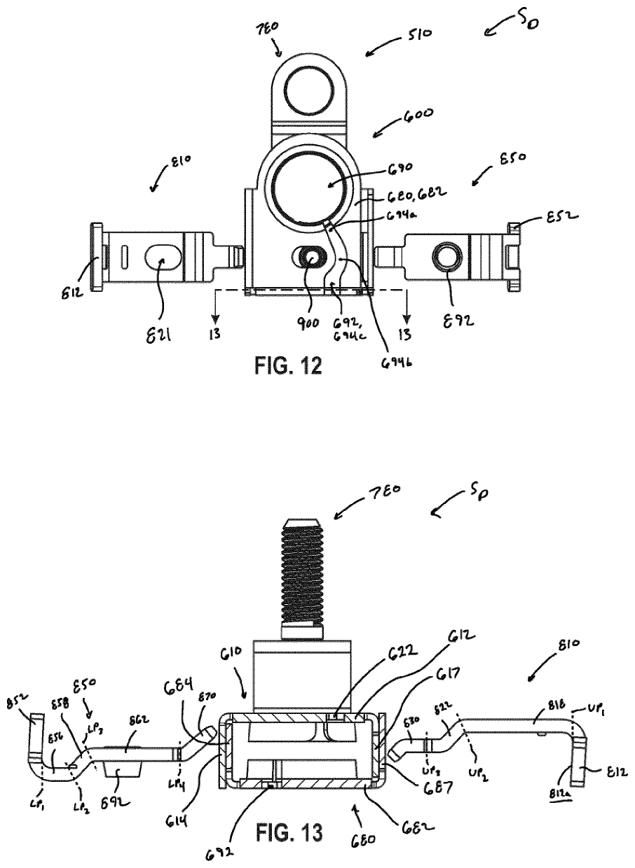

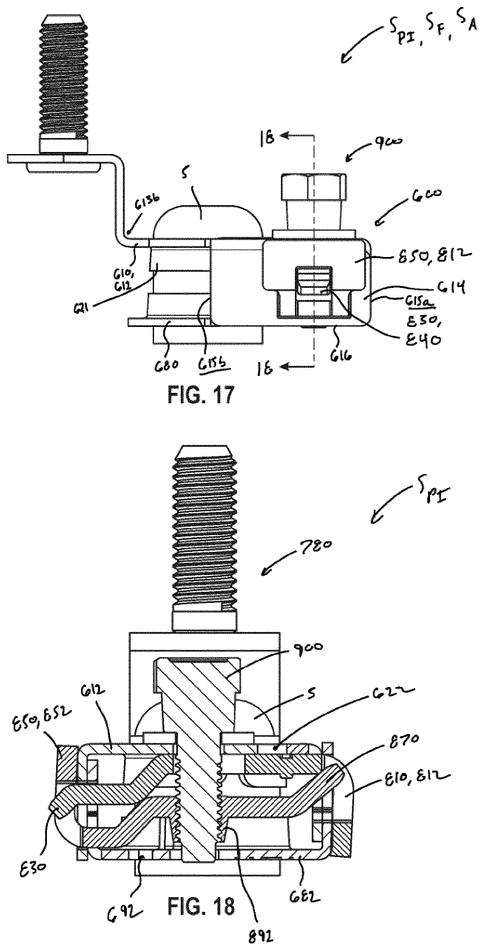

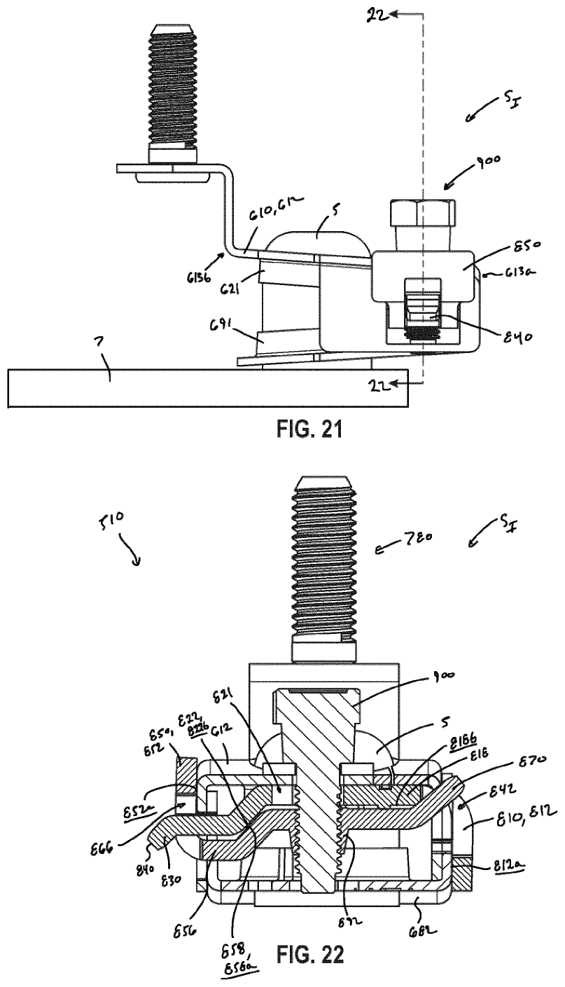

FIGS. 6-24 show an inventive battery terminal clamp assembly 510 in various stages of formation, assembly and use. In particular, FIGS. 6-8 show the battery terminal clamp assembly 510 in an assembled state S_{A}, FIGS. 10A-11G show the formation process of the clasping mechanism 600, FIGS. 12-16 show the steps undertaken in assembling the battery terminal clamp assembly 510, FIGS. 17-20 show the battery terminal clamp assembly 510 in a partially installed state, and FIGS. 21-24 show the battery terminal clamp assembly 510 in an installed or ready-to-use state. Referring to FIGS. 6-8, the battery terminal clamp assembly 510 comprises an inventive clasping mechanism 600 and a securement assembly 800.

a. Clasping Mechanism

The clasping mechanism 600 includes a body 604 and an attachment assembly 780. The attachment assembly 780 extends from an extent of the body 604 and is configured to electrically couple the body 604 to an external device, component, or part. In this clasping mechanism 600, the attachment assembly 780 includes an arrangement of walls bent relative to one another and an aperture 782 configured to receive an elongated battery cable fastener (not shown). It should be understood that in other embodiments, the attachment assembly 780 may have other configuration, including a projection extending from the bottom wall arrangement 680, a projection extending forward from either the top or bottom wall arrangements 610, 680, or one or more projections extending from the sides of the top or bottom wall arrangements 610, 680.

Unlike the conventional body 104 of the clasping mechanism 100, the body 604 of the inventive clasping mechanism 600 lacks an intermediate side wall that is integrally formed with and extends between the top and bottom wall arrangements 610, 680. Instead, said body 604 includes a top wall arrangement 610, a front wall 750, and a bottom wall arrangement 680. The top wall arrangement 610 includes: (i) a top wall 612 with a front edge 613a and a rear edge 613b, and (ii) a first top side wall or top left side wall 614 with a front surface 615a and rear surface 615b, and (iii) a second top side wall or top right side wall 617 with a front surface 618a and rear surface 618b. Unlike the conventional body 104, said top wall 612 lacks a front surface because the frontal extent of the top wall 612 is integrally formed with the front wall 750; instead, the top wall includes a front edge 613a that extends between the border between the top wall 612 and front wall 750. The top wall 612 includes: (i) an upper battery post aperture 620 configured to receive a battery post 5, (ii) depending battery post flange 621 that substantially surrounds the upper battery post aperture 620 and extends towards the bottom wall 682, and (iii) an upper slit 622, which is configured to shrink when the securement assembly 800 moves from an untightened state S_{UT} to a tightened state S_{T}. To allow for said shrinkage, the upper slit 622 extends from the upper battery post aperture 620 to the front edge 613a of the top wall 612, and includes three sections. The first upper substantially curvilinear section 624a extends from the upper battery post aperture 620 to an exterior apex 626, the second upper substantially curvilinear section 624b extends from the exterior apex 626 to an interior apex 628, and the third upper substantially linear section 624c extends from the interior apex 628 to the front wall 250. Unlike the conventional body 104, two of the sections 624a, 624b of the upper slit 622 are substantially curvilinear and said sections 624a, 624b are not linear. Additionally, one section 624c is not curvilinear and instead is substantially linear. In other words, the upper slit 622 includes two substantially curvilinear sections 624a, 624b and one substantially linear section 624c. Additionally and unlike the conventional body 104, the upper slit 622 includes three sections 624a, 624b, 624c and does not include less than three sections (e.g., one or two sections). In other embodiments, said upper slit 622 may include more (e.g., greater than three sections) or fewer sections (e.g., one or two section(s)).

The top left side wall 614 is integrally formed with the top wall 612, and has a front surface 615a that is substantially co-planar with: (i) the front edge 613a of the top wall 612, and (ii) the front surface 752 of the front wall 750. To integrally form the top left side wall 614 with the top wall 612, the top left side wall 614 is formed from the same piece of sheet metal stock 50 and is bent along left bend line B₁. When the top left side wall 614 is bent into position, it: (i) extends downward from the top wall 612, (ii) extends towards the bottom wall arrangement 680, and (iii) is configured to be perpendicular to the top and bottom walls 612, 682. A first pull bar opening or left pull bar opening 630 is formed in the top left side wall 614 and includes two rectangular extents. The first rectangular extent 632a of the first pull bar opening 630 extends from an edge that is positioned adjacent to the top wall 612 to the pull bar opening line P₁, and the second rectangular extent 632b of the first pull bar opening 630 extends from the pull bar opening line P₁ to an edge that is positioned near the lower edge 616 of the top left side wall 614.

The top right side wall 617 is integrally formed with the top wall 612, and has a front surface 618a that is substantially co-planar with: (i) the front edge 613a of the top wall 612, and (ii) the front surface 752 of the front wall 750. To integrally form the top right side wall 617 with the top wall 612, the top right side wall 617 is formed from the same piece of sheet metal stock 50 and is bent along right bend line B₂. When the top right side wall 617 is bent into position, it: (i) extends downward from the top wall 612, (ii) towards the bottom wall arrangement 680, and (iii) is configured to be perpendicular to the top and bottom walls 612, 682. A second pull bar opening or right pull bar opening 640 is formed in the top right side wall 617 and includes two rectangular extents. The first rectangular extent 642a of the second pull bar opening 640 extends from an edge that is positioned adjacent to the top wall 612 to the pull bar opening line P₂, and the second rectangular extent 642b of the second pull bar opening 640 extends from the pull bar opening line P₂ to an edge that is positioned near the lower edge 619 of the top right side wall 617. Unlike the conventional body 104, it should be understood that the top left side wall 614 and the right side wall 617 are positioned on opposite sides of the top wall 612 and are configured to substantially mirror one another. In other words, the configuration of the outer periphery of the side walls 614, 617 are substantially the same and the openings 630, 640 are the same.

Unlike the conventional body 104, the body 604 of the inventive battery terminal clamp assembly 510 includes the front wall 750. Other differences between the conventional body 104 and the inventive body 604 include: (i) the inclusion of a front wall 750 that does not make direct contact with the securement assembly 800, and (ii) a side wall that extends along the entire length of the battery post apertures 620, 690. Said front wall 750 has a front surface 752, top and bottom edges 754a, 754b, is integrally formed with the top and bottom walls 612, 682, and includes an front slit 760, which is configured to shrink when the securement assembly 800 moves from an untightened state S_{UT} to a tightened state S_{T}. To allow for said shrinkage, the front slit 760 extends from the upper slit 622 to the lower slit 692. Because the upper slit 622 is not vertically aligned with the lower slit 692, the front slit 760 angularly traverses a substantial extent of the front wall 750 in order to connect said slits 622, 692. Additional disclosure related to the configuration of the slits 622, 692, 760 is disclosed below in connection with FIG. 10A-10C. Because the conventional body 104 lacks a front wall 750 it also lacks a front slit 760 that extents between slit 112, 192.

Additionally, the front wall 750 is configured to be positioned: (i) adjacent to the front edges or surfaces 613a, 615a, 618a, 683a, 685a, 688a of the top and bottom wall arrangements 610, 680, and (ii) substantially perpendicular to the top and bottom walls 612, 682 (prior to the installed state S_{I}). To integrally form the front wall 750 with the top and bottom walls 612, 682, the front wall 750 is formed from the same piece of sheet metal stock 50 and is bent along top and bottom bend lines B₃, B₄. As shown in FIG. 11A-11G, the top and bottom bend lines B₃, B₄: (i) extend along the entire width of the front wall 750 (extending between first side edge 751a and second side edge 751b), (ii) are positioned substantially parallel to the front edges or surfaces 613a, 615a, 618a, 683a, 685a, 688a, and (iii) positioned substantially parallel with a frontal surface 644 of the pull bar opening 640. In other words, the top and bottom bend lines B₃, B₄ are not perpendicular to the front edges or surfaces 613a, 615a, 618a, 683a, 685a, 688a, nor does it run along the length of the top and bottom walls 612, 682.

The front wall 750 has a width W_{FW}: (i) substantially equal to the width W_{T} of the top wall 612, which extends between the first and second side walls 614, 617, and (ii) substantially equal to an extent of the width WB of the bottom wall 682, which extends between the first and second side walls 684, 687. As such, the width of the top and bottom bend lines B₃, B₄ is substantially equal to the width W_{T} of the top wall 612, and substantially equal to an extent of the width WB of the bottom wall 682. In other words, the width W_{FW} of the front wall 750 and the width of the top and bottom bend lines B₃, B₄ is not equal to the length L_{T}, L_{B} of the top and bottom walls 612, 682 (which extends between the front and rear edges or surfaces 613a, 613b, 683a, 683b). Additionally, from the above description and the Figures, it should be understood that the clasping mechanism 600 lacks a wall that is positioned on the opposite of the front wall 750. In other words, unlike the conventional body 104, the body 604 lacks a wall positioned on the opposite side of the wall that is integrally formed with the top and bottom wall arrangements 610, 680.

The bottom wall arrangement 680 includes: (i) a bottom wall 682 with a front edge 683a and a rear surface 683b, and (ii) a first bottom side wall or bottom left side wall 684 with a front surface 685a and rear surface 685b, and (iii) a second bottom side wall or bottom right side wall 687 with a front surface 688a and rear surface 688b. Unlike the conventional body 104, said bottom wall 682 lacks a front surface because the frontal extent of the bottom wall 682 is integrally formed with the front wall 750; instead, the bottom wall includes a front edge 683a that extends between the border between the bottom wall 682 and front wall 750. The bottom wall 682 includes: (i) a lower battery post aperture 690 that is configured to receive a battery post 5, (ii) upwardly depending battery post flange 691 that substantially surrounds the lower battery post aperture 690 and extends towards the top wall 618, and (iii) a lower slit 692, which is configured to shrink when the securement assembly 800 moves from an untightened state S_{UT} to a tightened state S_{T}. To allow for said shrinkage, the lower slit 692 extends from the lower battery post aperture 690 to the front edge 683a of the bottom wall 682, and includes three sections. The first lower substantially curvilinear section 694a extends from the lower battery post aperture 690 to an exterior apex 696, the second lower substantially curvilinear section 694b extends from the exterior apex 696 to an interior apex 698, and the third lower substantially linear section 694c extends from the interior apex 698 to the front wall 250. As described above, two of the sections 694a, 694b of the lower slit 692 are substantially curvilinear, and said sections 694a, 694b are not linear. Additionally, one section 694c is not curvilinear and instead is substantially linear. In other words, the lower slit 692 includes two substantially curvilinear sections 694a, 694b and one substantially linear section 694c. Additionally and unlike the conventional body 104, the lower slit 692 includes three sections 694a, 694b, 694c and does not include less than three sections (e.g., one or two sections). In other embodiments, said lower slit 692 may include more (e.g., greater than three sections) or fewer sections (e.g., one or two section(s)). As show in the Figures, while the lower slit 692 and upper slit 622 are not vertically aligned, the configuration of the lower slit 692 substantially matches the configuration of the upper slit 622.

The bottom left side wall 684 is integrally formed with the bottom wall 682 and the front surface 685a is substantially co-planar with: (i) the front edge 683a of the bottom wall 682, and (ii) front edge 752 of the front wall 750. To integrally form the bottom left side wall 684 with the bottom wall 682, the bottom left side wall 684 is formed from the same piece of sheet metal stock 50 and is bent along left bend line B₁. When the bottom left side wall 684 is bent into position, it: (i) extends upward from the bottom wall 682, (ii) extends towards the top wall arrangement 610, and (iii) is configured to be perpendicular to the bottom wall 682. A first pull bar opening or left pull bar opening 700 is formed in the bottom left side wall 684 and includes two rectangular extents. The first rectangular extent 702a of the first pull bar opening 700 extends from an edge that is positioned adjacent to the bottom wall 682 to the pull bar opening line P₃, and the second rectangular extent 702b of the first pull bar opening 700 extends from the pull bar opening line P₃ to an edge that is positioned near the lower edge 686 of the bottom left side wall 684.

The second bottom side wall or bottom right side wall 687 is integrally formed with the bottom wall 682 and the front surface 688a is substantially co-planar with: (i) the front edge 683a of the bottom wall 682, and (ii) front edge 752 of the front wall 750. To integrally form the bottom right side wall 687 with the bottom wall 682, the bottom right side wall 687 is formed from the same piece of sheet metal stock 50 and is bent along right bend line B₂. When the bottom right side wall 687 is bent into position, it: (i) extends upward from the bottom wall 682, (ii) towards the top wall arrangement 610, and (iii) is configured to be perpendicular to the bottom wall 682. A second pull bar opening or right pull bar opening 710 is formed in the bottom right side wall 687 and includes two rectangular extents. The first rectangular extent 712a of the second pull bar opening 710 extends from an edge that is positioned adjacent to the bottom wall 682 to the pull bar opening line P₄, and the second rectangular extent 712b of the second pull bar opening 710 extends from the pull bar opening line P₄ to an edge that is positioned near the lower edge 689 of the bottom left side wall 684. Unlike the conventional body 104, it should be understood that the bottom left side wall 684 and the bottom right side wall 687 are positioned on opposite sides of the bottom wall 682 and have outer peripheries that substantially mirror one another. However, unlike the top side walls 614, 617, the openings 700, 710 in the bottom side walls 684, 687 do not match one another. In other words and unlike body 104, body 604 includes four openings 630, 640, 700, 710 (not three) and the configuration of all four openings do not match one another. Instead, the configuration of three openings 630, 640, 710 match each other and the configuration of the other opening 700 does not match the configuration of the other openings.

b. Securement Assembly

Securement assembly 800 in a central, top down drive system comprised of: (i) an upper pull bar 810, (ii) a lower pull bar 850, and (iii) an elongated coupler 900. The pull bars 810, 850 and the coupler 900 function together to allow for the application of a compression force on the clasping mechanism 100, whereby said compression force on the clasping mechanism 100 can form a clamping force Fc on a battery post 5. The upper pull bar 810 includes: (i) a head or outer flange 812, (ii) a body 814 having a first or substantially linear portion 818, a second or angled portion 822, and a third or interacting projection 830. Specifically, the first substantially linear portion 818 extends between a first upper pull bar UP₁ line that is vertically aligned with an extent of the inner surface 812a of the head 812 and a second upper pull bar UP₂ line that angularly extends through the bend positioned between the linear portion 818 and the angled portion 822. The angled portion 822 extends between the second upper pull bar UP₂ line and a third upper pull bar UP₃ line that is aligned with the shoulders 826a, 826b of the angled portion 822, while the interacting projection 830 extends from the third upper pull bar UP₃ to a free end 840. The angled portion 822 and the interacting projection 830 both slope downward towards a plane that extends from the lowermost surface 813 of the head 812. The upper pull bar 810 includes two openings, wherein: (i) a first opening is formed in the substantially linear portion 818 and is an oblong coupler opening 821, and (ii) the second opening is formed in the outer flange 812 and the curvilinear wall that extends between said outer flange 812 and substantially linear portion 818 and is a lower pull bar receiver 842.

The lower pull bar 850 includes: (i) a head or outer flange 852, (ii) a body 854 having a first or linear portion 856, a second or angled portion 858, a third or substantially linear portion 862, and a fourth or interacting projection 870. Specifically, the first or linear portion 856 extends between a first lower pull bar LP₁ line that is vertically aligned with an extent of the inner surface 852a of the head or outer flange 852 and a second lower pull bar LP₂ line that angularly extends through the bend positioned between the first portion 856 and the angled portion 858. The angled portion 858 extends between the second lower pull bar LP₂ line and a third lower pull bar LP₃ line that angularly extends through the bend positioned between the angled portion 858 and the substantially linear portion 862. The linear portion 862 extends between the third lower pull bar LP₃ line and a fourth lower pull bar LP₃ line that is aligned with the shoulders 866a, 866b of the linear portion 862, while the interacting projection 870 extends from the fourth lower pull bar LP₄ to a free end 880. The angled portion 858 and the interacting projection 870 both slope upward towards a plane that extends from the uppermost surface 853 of the head 852. The lower pull bar 850 includes one opening 866 and a thermoformed threaded coupler 892. Said opening is formed in the outer flange 852 and the curvilinear wall that extends between said outer flange 852 and substantially linear portion 856a and is an upper pull bar receiver 866. And said thermoformed threaded coupler is positioned in the substantially linear portion 862 and extends downward from an upper surface 862a of the lower pull bar 850. The thermoformed threaded coupler 892 is designed and configured to function with the threaded elongated coupler 900. It should be understood in other embodiments, the securement assembly 800 may be replaced with other securement assemblies (e.g., the assembly disclosed in U.S. Pat. No. 10,008,789, angled drive top-down, and/or lever action).

c. Assembly and Use of the Battery Terminal Clamp Assembly

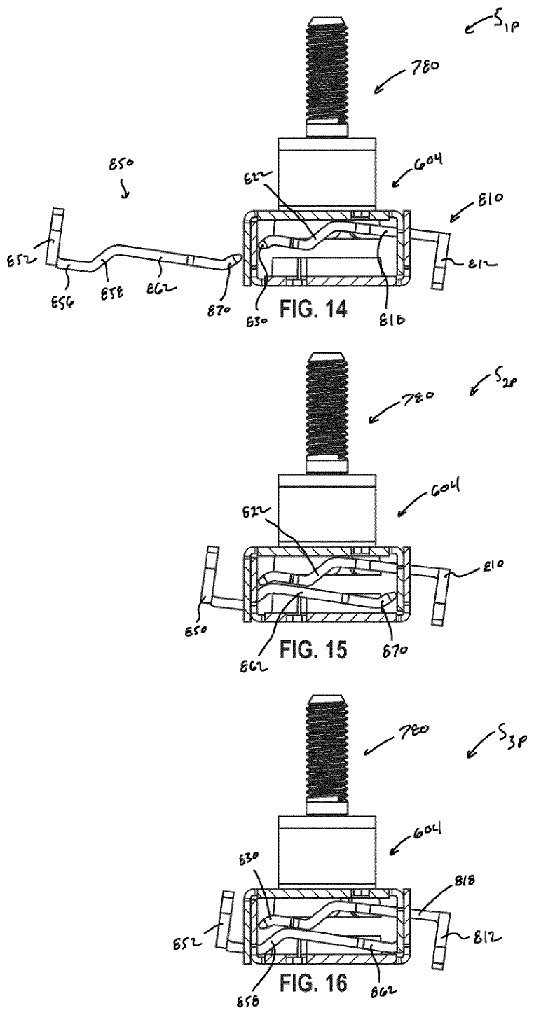

FIGS. 12-17 show the movement of the battery terminal clamp assembly 510 from a disassembled state S_{D} to an assembled state S_{A}. The first step 910 in this process is shown in FIGS. 12 and 13 where the securement assembly 800 are separated from the clasping mechanism 100. Next and as shown in FIG. 14, the assembly 510 moves from a disassembled state S_{D} to a first partially assembled state S_{1P} when the upper pull bar 810 is inserted into the body 604, thought right pull bar opening 640, 710, and is angled upward towards the top wall 612. Next and as shown in FIG. 15, the assembly 510 moves from the first partially assembled state S_{1P} to a second partially assembled state S₂P when the lower pull bar 850 is inserted into the body 604, thought left pull bar opening 630, 700, and is angled downward towards the bottom wall 682. In this position, the upper surface 822a, 830a of the angled portion 822 and interacting projection 830 of the lower pull bar 850 are positioned adjacent to the lower surface 858a of the linear portion 858 of the upper pull bar 810. Next and as shown in FIG. 16, the assembly 510 moves from the second partially assembled state S_{2P} to a third partially assembled state S_{3P} when the assemblies continues to insert the lower pull bar 850 is inserted into the body 604. Finally, the lower pull bar 850 is fully inserted into the body 604, the interacting projection 870 is inserted in the lower pull bar receiver 842, the interacting projection 830 is inserted in the upper pull bar receiver 866, and the coupler 900 is inserted through an opening in the top wall 612 and oblong coupler opening 821, and into the thermoformed threaded coupler 892. Once this last step occurs, the battery terminal clamp assembly 510 moves to the assembled state S_{A}.

FIGS. 10A-10C show a substantially planar piece of sheet metal stock 550 having: (i) a top edge 552a, (ii) a bottom edge 552b, and (iii) outlines of two clasping mechanism blanks 554a-554b positioned between the top and bottom edges 552a-552b. The clasping mechanism blanks 554a-554b include a first and second axis A₁, A₂ that extends through the center of an aperture 782a of the attachment assembly 780. Unlike the conventional body 104, the combination of slits 622, 692, 760 form a continuous slit or clamping slit 770 contained in the inventive body 604. Said continuous slit 770 follows a circuitous path between the upper battery post aperture 620 and the lower battery post aperture 690. The circuitous path of the continuous slit 770 substantially forms a reverse “S” shape around said axis A₁, A₂ and crosses at the intersection between a horizontal central axis A_{C} and the vertical axis A₁, A₂. In other words, the continuous slit 770 forms a shape that is reflected about horizontal central axis A_{C} and mirrored about axis A₁, A₂. It should also be understood that the continuous slit 770 is fully contained within the clasping mechanism 600 and does not extend to an external surface of said mechanism 600. In contrast to the inventive clasping mechanism 600, both of the gaps 122, 192 of the conventional clasping mechanism 100 extend from the battery post aperture 120, 190 to the front surface 113a, 184.

Positioned on the sheet metal stock 550 and between the clasping mechanism blanks 554a-554b is an extent of scrap or engineered scrap 556 due to the configuration of the clasping mechanisms 600. This engineered scrap 556 is an extent of the metal stock 550 that cannot be used due to the configuration of the blanks 554a-554b and the spacing needed to cut said blanks 554a-554b from the stock 550. Specifically, the engineered scrap 556 includes seven extents 560, 562, 564, 566, 568, 570, and 572. The first extent 560 of engineered scrap 556 has a first area A₁ that extends between: (i) a first axis A₁ that extends through the center of an aperture 782a that is configured to receive an elongated battery cable fastener, (ii) a second axis A₂ that extends through an aperture 782b that is configured to receive an elongated battery cable fastener, (iii) the top edge of the blank 552a, and (iv) a first engineered scrap line ES₁ that is aligned with an uppermost extent of the attachment assembly 780. The second extent 562 of engineered scrap 556 has a second area A₂ that extends between: (i) the left edge of the first clasping mechanism blank 554a, namely comprised of edges associated with the attachment assembly 780 and the top wall 612, (ii) the right edge of the second clasping mechanism blank 554b, namely comprised of edges associated with the attachment assembly 280 and the top wall 612, (iii) the first engineered scrap line ES₁, and (iv) a second engineered scrap line ES₂ that is aligned with the rear surfaces of the 615b, 618b of the first and second side walls 614, 617.

The third extent 564 of engineered scrap 556 has a third area A₃ that extends between: (i) lower edge 616 of the top left side wall 614, (ii) the lower edge 619 of the top right side wall 617, (iii) the second engineered scrap line ES₂, and (iv) a third engineered scrap line ES₃ that is aligned with the front surfaces 615b, 618b of the first and second side walls 614, 617. The fourth extent 566 of engineered scrap 556 has a fourth area A₄ that extends between: (i) the first side edge 751a of the front wall 750, (ii) the second side edge 751b of the front wall 750, (iii) the third engineered scrap line ES₂, and (iv) a fourth engineered scrap line ES₄ that is aligned with the rear surfaces 685b, 688b of the first and second side walls 684, 687. The fifth extent 568 of engineered scrap 556 has a fifth area A₅ that extends between: (i) lower edge 686 of the top left side wall 614, (ii) the lower edge 689 of the top right side wall 617, (iii) the fourth engineered scrap line ES₄, and (iv) a fifth engineered scrap line ES₅ that is aligned with the front surfaces 685a, 688a of the first and second side walls 684, 687.

The sixth extent 570 of engineered scrap 556 has a sixth area A₆ that extends between: (i) the left edge of the first clasping mechanism blank 554a, namely the edge associated with the bottom wall 682, (ii) the right edge of the second clasping mechanism blank 554b, namely the edge associated with the bottom wall 682, (iii) the fifth engineered scrap line ES₅, and (iv) a sixth engineered scrap line ES₆ that is aligned with the rear surface of the 685b of the bottom wall 682. The seventh extent 572 of engineered scrap 556 has a seventh area A₇ that extends between: (i) the first axis A₁, (ii) the second axis A₂, (iii) bottom edge of the blank 52b, and (iv) the sixth engineered scrap line ES₆. As such, the engineered scrap 556 has an area A_{ES} equal to the sum of the first through the seventh areas A₁-A₇. In other words, the engineered scrap 556 has an area A_{ES} that substantially extends between: (i) the first axis A₁, (ii) the second axis A₂, (iii) the left edge of the first clasping mechanism blank 54a, (iv) the right edge of the second clasping mechanism blank 54b, (v) top edge of the blank 52a, and (iv) the bottom edge of the blank 52b.

Comparing the conventional clasping mechanism blanks 54a-54b with the inventive clasping mechanism blanks 554a-554b, conventional engineered scrap 56 has four extents while the inventive engineered scrap 556 has seven extents. The area A_{ES} of the four extents of the conventional engineered scrap 56 is approximately 40% larger than the area A_{ES} of the seven extents of the inventive engineered scrap 556. In other words, the inventive assembly 510 reduces material waste or engineered scrap by more than 40%. This reduction can best be seen when comparing how the distance between the axis was reduced when comparing the blanks 54a-54b with blanks 554a-554b. Even though inventive assembly 510 contain more material—namely, 100,000 clasping mechanisms 600 weigh 1,500 more pounds than of 100,000 clasping mechanism 100—the manufacturing of the battery terminal clamp assembly 510 utilize less material due to the reduction in engineered scrap. The reduction in the scrap is significant, especially when manufacturing these components at scale and are formed from expensive materials (e.g., copper, aluminum, plated copper, copper-clad on another material, or any combination thereof).

Once one of the clasping mechanism blanks 554a-554b is removed from the sheet metal 550, each blank 554a-554b undergoes a process that converts said blank 554a-554b from an unfolded state Su to a folded state S_{F}. This seven-step process is shown in FIGS. 11A-11G, wherein step 1 (570) is the step of acquiring the blank 554a, step 2 (572) includes form the upper and lower battery post apertures 620, 692, step 3 (574) includes forming the side walls 614, 617, 684, 687, steps 4 and 5 (576, 578) includes bending an extent of the attachment assembly 780, step 6 (580) places the bottom wall 682 perpendicular to the top wall 612, and step 7 (582) moves the bottom wall 682 from its perpendicular arrangement with the top wall 612 in step 6 to substantially parallel with the top wall 612. In comparison to the process described above in folding the conventional clasping mechanism blank 54a, this disclosed process in folding the clasping mechanism blank 554a requires one less step. Reducing the number of steps needed to convert each blank 554a-554b from the unfolded state Su to the folded state S_{F} is desired because it makes the battery terminal clamp assembly 510 less expensive to manufacture.

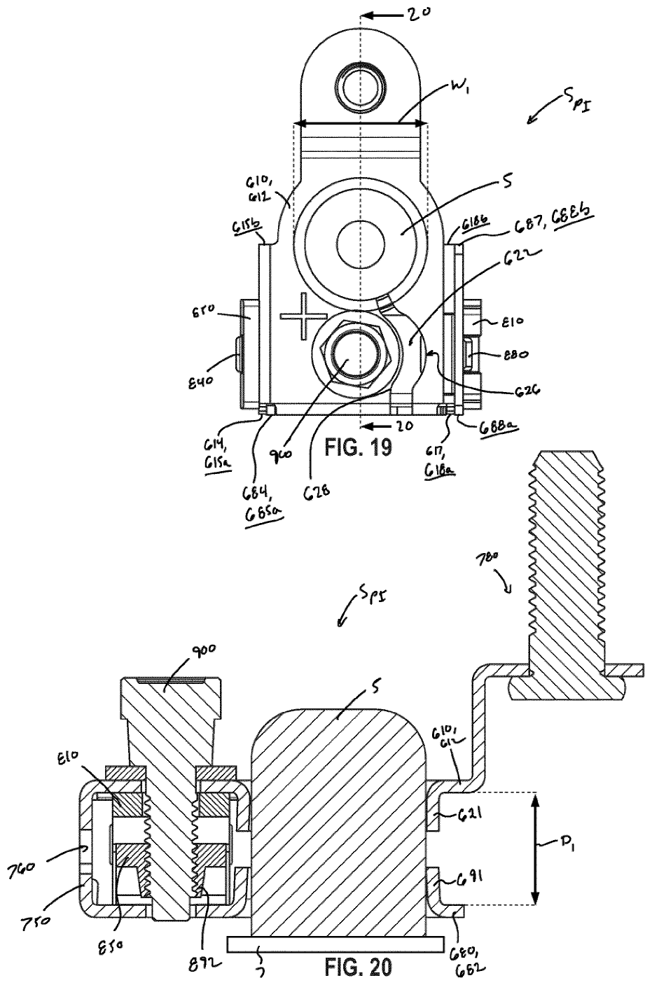

As shown in FIGS. 17-20, after the battery terminal clamp assembly 510 is in the assembled state S_{A}, the installer can connect the attachment assembly 780 and place a battery post 5 within the upper and lower battery post apertures 620, 690 to move the assembly 510 is a partially installed state S_{PI}. In this partially installed state S_{PI}, the securement assembly 800 can be in either an untightened state S_{UT} or a tightened state S_{T}. In the untightened state S_{UT}: (i) an extent (e.g., thermoformed threaded coupler 892) of the lower pull bar 850 is positioned adjacent to the bottom wall 682, (ii) an extent (e.g., substantially linear portion 818) of the upper pull bar 810 is positioned adjacent to the top wall 612, (iii) the securement assembly 800 does not apply an appreciable compressive force or only applies a nominal compressive force on the clasping mechanism 600, (iv) the battery terminal clamp assembly 510 does not apply a clamping force Fc on the battery post 5, (v) the top wall 612 is substantially parallel with the bottom wall 682 (FIGS. 17 and 20), (vi) the battery post apertures 620, 690 are substantially circular (FIG. 19), (vii) the slits 622, 692 are in their original or uncompressed state (FIGS. 18 and 19), and (viii) a lower surface of the top wall 612 is positioned a first or partially installed distance D₁ away from an upper surface of the bottom wall 682. To move the securement assembly 800 from the untightened state S_{UT} to the tightened state S_{T}, a user turns the coupler 900 in a clockwise direction. By turning said coupler 900 in a clockwise direction, the lower pull bar 850 is pulled upward and towards the top wall 612. This upward pulling force, causes interactions between: (i) the upper surface 870a of the interacting projection 870 of the lower pull bar 850 and lower surface 818b of the linear portion 818 of the upper pull bar 810, and (ii) the upper surface 858a of the angled portion 858 of the lower pull bar 850 and lower surface 822b of the angled portion 822 of the upper pull bar 810. This interaction causes the outer flanges 812, 852 to apply a compression force on the clasping mechanism 600.

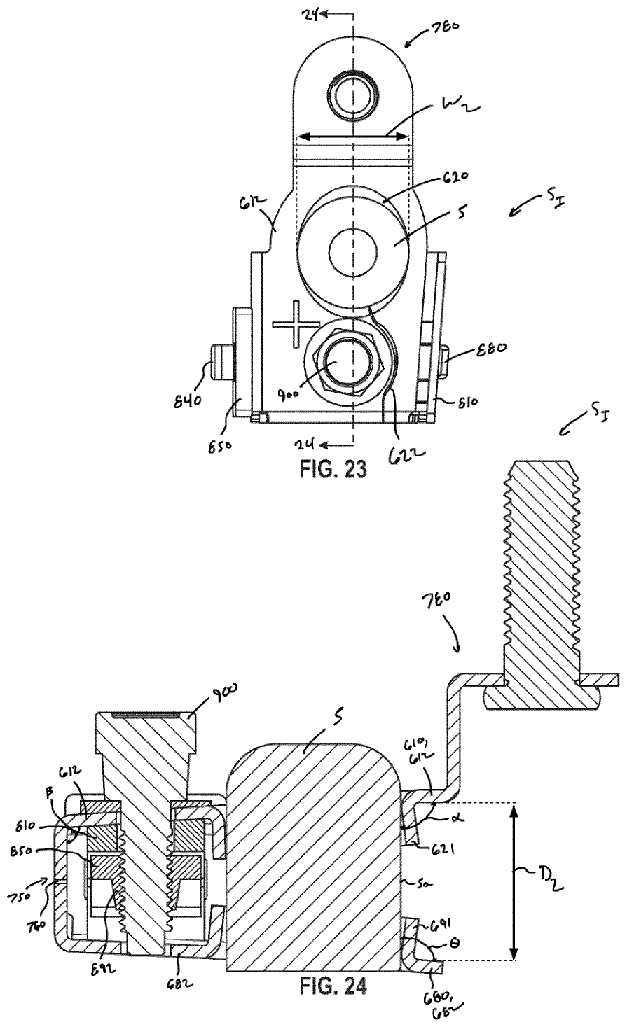

As shown in FIGS. 21-24, when the securement assembly 800 has been torqued to a set value (e.g., between 7.6 and 10.4 Nm, and preferably 9 Nm), the securement assembly 800 is in a tightened state S_{T} and the assembly 510 is in an installed state S_{I}. In the installed state S_{I}: (i) the substantially linear portion 862 of the lower pull bar 850 is positioned adjacent to the substantially linear portion 818 of the upper pull bar 810, (ii) an extent (e.g., substantially linear portion 818) of the upper pull bar 810 is positioned adjacent to the top wall 612, (iii) the securement assembly 800 applies a sufficient compression force (e.g., a force greater than a nominal force) on the clasping mechanism 600, (iv) the battery terminal clamp assembly 510 apply a clamping force Fc on the battery post 5, (v) the width of the battery post apertures 620, 690 is shrunken from their original state (FIG. 19) to a reduced state (FIG. 23), (vi) the top and bottom walls 612, 682 are angled relative to the front wall 750, (vii) the top wall 612 is not parallel with the bottom wall 682, (viii) the battery post apertures 620, 690 are not substantially circular, (ix) the slits 622, 692, 760 shrunken from their original state (FIG. 19) to a shrunken state (FIG. 23), and (x) a lower surface of the top wall 612 is positioned a second or installed distance D₂ away from an upper surface of the bottom wall 682, wherein the second or installed distance D₂ is greater than the first or partially installed distance D₁. Additional disclosure about the operation and functionality of the securement assembly 800 is disclosed in detail in U.S. Pat. No. 9,608,254, which is hereby incorporated by reference.

Unlike the conventional battery terminal clamp assembly 10 movement from the partially installed state S_{PI} to the installed state S_{I}, movement of the inventive battery terminal clamp assembly 510 from the partially installed state S_{PI} to the installed state S_{I} provides a “spreading effect.” As the user moves the securement assembly 800 from the untightened state S_{UT} to a tightened state S_{T} by turning the coupler 900 clockwise, the width of the wall (e.g., width W_{T} of the top wall 612, W_{FW} of the front wall 750, and width WB of the bottom wall 682) that form the body 604 and the size of the slits 622, 692, 760 formed is said walls are reduced. This reduction of the width of the walls 612, 682, 750 causes the distance separating the top wall 612 and the bottom wall 682 to increase from the first distance D₁ to a second distance D₂. The increase in distance between said walls 612, 682 can be denoted as a “spreading effect.” When the battery terminal clamp assembly 510 has experienced this spreading effect, the: (i) top wall 612 is no longer parallel to the bottom wall 682, (ii) top wall 612 is angularly positioned relative to the bottom wall 682, (iii) the top and bottom walls 612, 682 not to be positioned substantially perpendicular with the front wall 750, (iv) the top and bottom walls 612, 682 are angularly positioned relative to the front wall 750, (v) a positive angle alpha is formed between a rear extent of the top wall 612 of the clasping mechanism 600 and a substantially vertical wall 5a of the battery post 5, (vi) a negative angle theta is formed between a rear extent of the bottom wall 682 of the clasping mechanism 600 and the substantially vertical wall 5a of the battery post 5. In other words, the interior angle beta formed between the top wall 612 and the front wall 750 moves from approximately 90° to an angle between 91° and 135°. Stated in another way: (i) prior to installment on a battery post 5, a pre-install distance D₁ extends between the lower surface of the top wall 612 and the upper surface of the bottom wall 682, and (ii) after installment on a battery post 5 and moving the securement assembly 800 to the tightened state S_{T}, an installed distance D₂ extends between the lower surface of the top wall 612 and the upper surface of the bottom wall 682, and wherein the installed distance D₂ is greater than the pre-install distance D₁. The “spreading effect” increases securement between the assembly 510 and the battery post 5 and retention of the assembly 510 on the post 5, especially over time during the operation of the vehicle in which the battery and assembly 510 are installed. As stated above, conventional battery terminal clamp assembly 10 do not undergo the spreading effect disclosed in connection with the inventive battery terminal clamp assembly 510.

Accordingly, when the assembly 510 is placed on a battery post 5 and the securement assembly 800 is torqued to a first value (same value as discussed above in connection with the conventional battery terminal clamp assembly 10, namely—between 7.6 and 10.4 Nm, and preferably 9 Nm), the spreading effect leads the assembly 510 to have a pull-off force that is more than 980 N, and preferably is more than 2,300 N, and most preferably is more than 3,000 N, and could be up to 3,700 N. Using the same torqued values between the conventional battery terminal clamp assembly 10 and the inventive assembly 510, the pull-off force of the inventive assembly 510 is at least 5% greater, preferably is more than 15%, and most preferably is more than 40% greater than the pull-off force associated with the conventional battery terminal clamp assembly 10. This increased pull-off force provides the assembly 510 with increased securement and retention on the battery post 5, which increases durability and reliability of the battery and battery terminal clamp assembly 510 during prolonged operation of the vehicle in which the battery and battery terminal clamp assembly 510 are installed.

### Second Embodiment—Inventive Battery Terminal Clamp Assembly

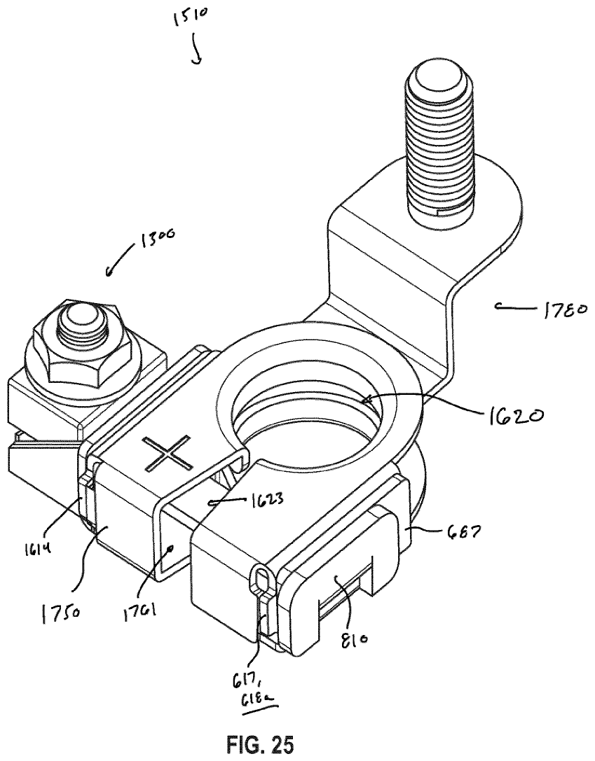

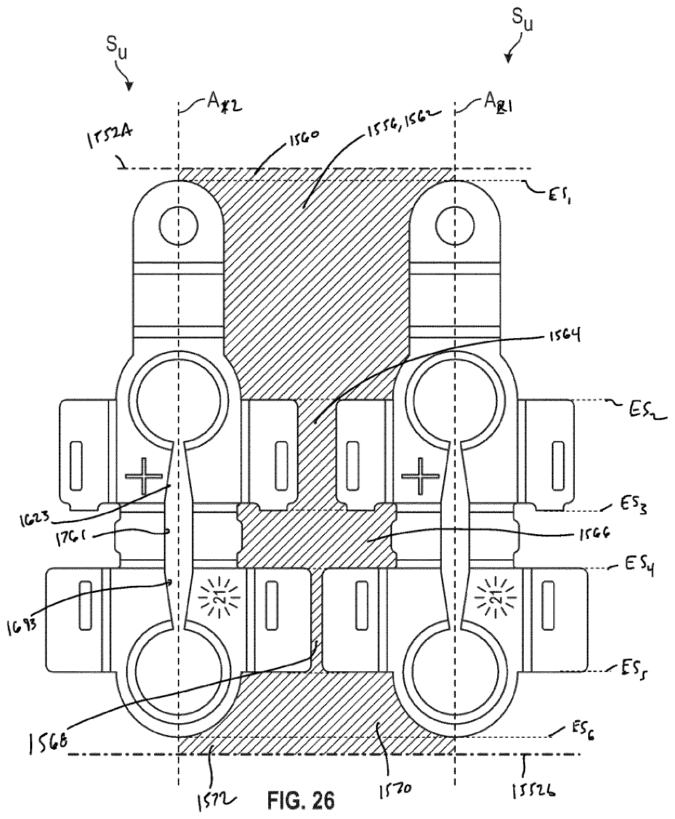

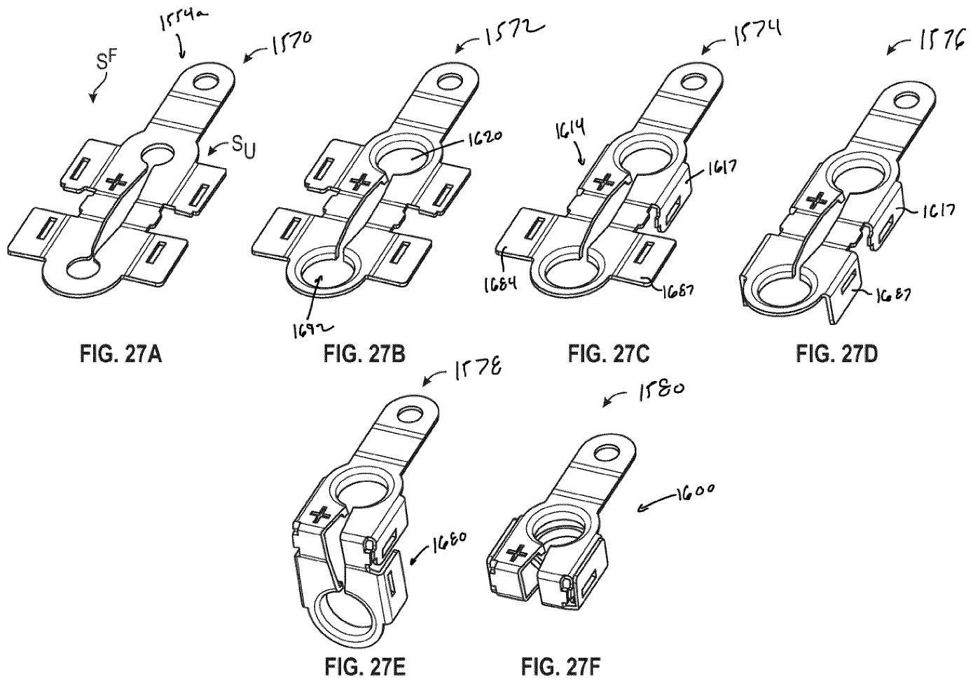

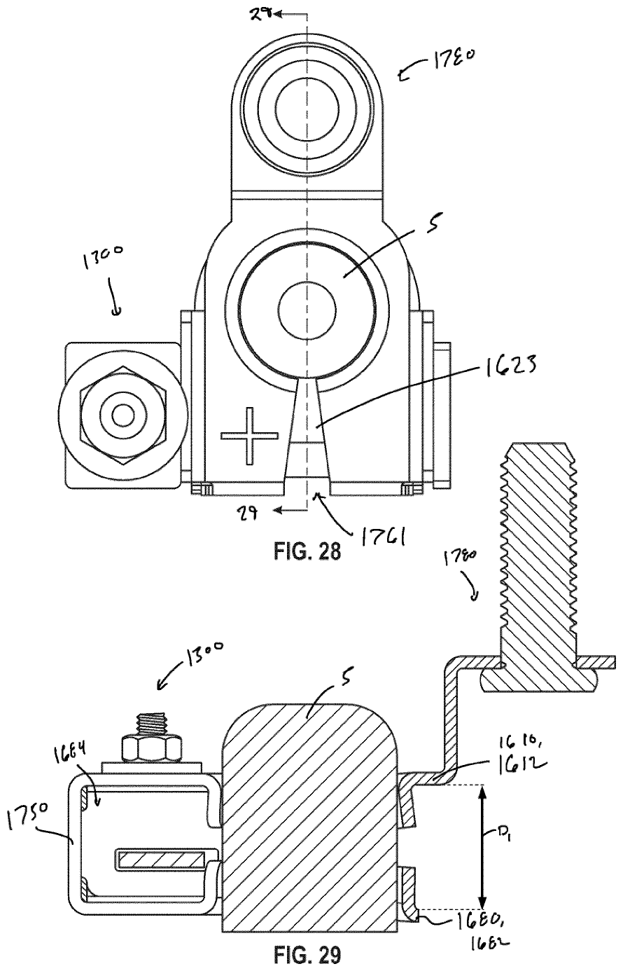

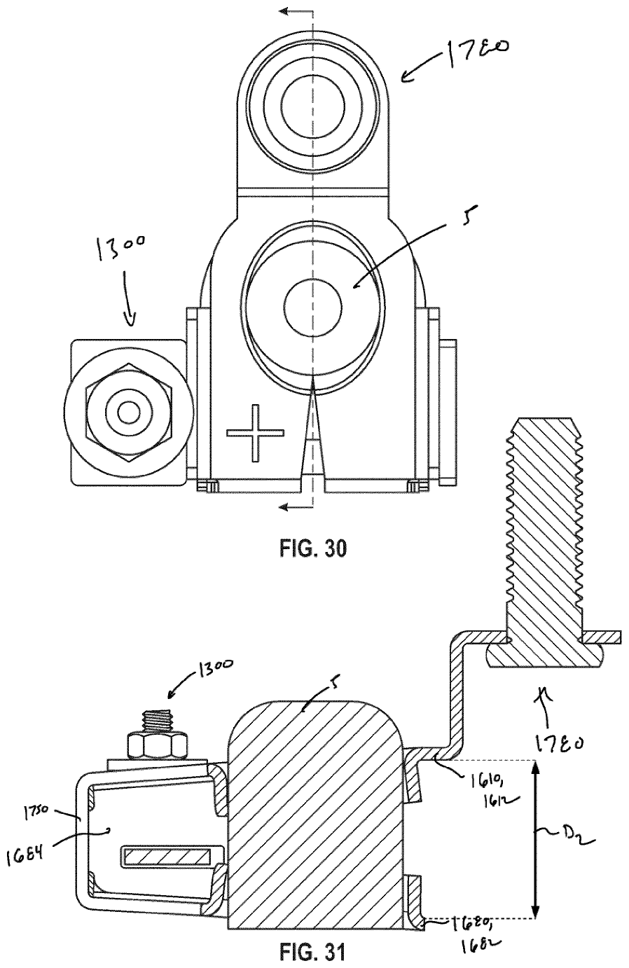

FIGS. 25-31 show a second embodiment of the battery terminal clamp assembly 1510 comprises an inventive clasping mechanism 1600 and a securement assembly 1300. Because a substantial majority of the structures contacted in this embodiment of the assembly 1510 are similar to either the first embodiment of the assembly 1510 or the conventional embodiment of the battery terminal clamp assembly 10, it should be understood that reference numbers that are shown in the figures may be omitted from the specification for sake of brevity as like structures have like numbers. For example, the disclosure in connection with the securement assembly 300 is not repeated herein, but it applies to securement assembly 1300, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. The primary difference between the first and second embodiments of the clasping mechanisms 600, 1600 is the formation of the slits 622, 692, 760, 1622, 1692, 1760. Instead of utilizing the slits 622, 692, 760 disclosed in the first embodiment of the assembly 600, the second embodiment of the assembly 1600 includes two wedge shaped gaps 1623, 1693 that are aligned with one another and said gaps 1623, 1693 are connected with a linear front wall gap 1761. While the shape of the slits or gaps 622, 692, 760, 1622, 1692, 1760 are different across these embodiments, the advantages of the clasping mechanism 600 over the conventional clasping mechanism 100 apply in equal force to this clasping mechanism 1600. Accordingly, other shapes (e.g., circular, angular, curvilinear, linear, off-set from one another, non-off set from on another) or configurations (e.g., or multiple gaps formed in any one of the top, bottom, or front walls) of the slits or gaps are contemplated by this disclosure. In other words, clasping mechanism 1600 includes the above described advantages that the clasping mechanism 600 over the conventional clasping mechanism 100.

Related Information for the Assembly and Materials that are Incorporated by Reference

The assemblies 510 and 1510 meet or exceed relevant parts of the following specifications: (i) Ford Connector SDS EL-0176 and RQT-180107-008728 Specifications, (ii) FCA PF.90100, (iii) GMW3191, (iv) GMW3172, (v) GMCG3801, (vi) USCAR 2, (vii) USCAR 21, (viii) USCAR 38, (ix) SAE Specifications, (x) ASTM Specifications, (xi) DIN Specifications. The assemblies 510 and 1510 are compliant to T4/V4/D₂, wherein the assemblies 510 and 1510 are meets and exceeds: (i) T4 is exposure of the system 10 to 150° C., (ii) V4 is severe vibration, and (iii) D2 is 200 k mile durability.

Ford Connector Specifications, including SDS EL-0176 and RQT-180107-008728, which is fully incorporated herein by reference and made a part hereof.

FCA and GM Specifications, including FCA PF.90100, GMW3191, GMW3172, GMCG3801, which is fully incorporated herein by reference and made a part hereof.

SAE Specifications, including: J1742_201003 entitled, “Connections for High Voltage On-Board Vehicle Electrical Wiring Harnesses—Test Methods and General Performance Requirements,” last revised in March 2010, each of which is fully incorporated herein by reference and made a part hereof.

DIN Specification, including Connectors for electronic equipment—Tests and measurements—Part 5-2: Current-carrying capacity tests; Test 5b: Current-temperature derating (IEC 60512-5-2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

Other standards, including Federal Test Standard 101C and 4046, each of which is fully incorporated herein by reference and made a part hereof. While some implementations have been illustrated and described, numerous modifications come to mind without significantly departing from the spirit of the disclosure; and the scope of protection is only limited by the scope of the accompanying claims. For example, shapes of the components described above may be changed to: a triangular prism, a pentagonal prism, a hexagonal prism, octagonal prism, sphere, a cone, a tetrahedron, a cuboid, a dodecahedron, an icosahedron, an octahedron, an ellipsoid, or any other similar shape. Additionally, the assemblies 510 and 1510 may be modified to include: anti-rotation features, poke-yoke features, fused connections, wire routing, multi-grip eyelets, over-molded, free spinning nuts and bolts.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. A battery terminal clamp assembly comprising:
a clasping mechanism having:
a top wall with an upper battery post aperture and an upper slit, wherein the upper battery post aperture is configured to receive an extent of a battery post,
a bottom wall with a lower battery post aperture and a lower slit, wherein the upper battery post aperture is configured to receive an extent of the battery post, and
a front wall integrally extending between the top and bottom walls and including a front slit, and wherein the upper slit, the lower slit, and the front slit are arranged to form a continuous slit that extends from the upper battery post aperture, across the front wall and to the lower battery post aperture.

2. The battery terminal clamp assembly of claim 1, wherein when the battery post resides within the upper and lower battery post apertures and a securement assembly applies a sufficient compressive force on the clasping mechanism, the top wall of the clasping mechanism is not substantially parallel with the bottom wall of the clasping mechanism.

3. The battery terminal clamp assembly of claim 1, wherein when the battery post is positioned in the upper and lower battery post apertures and a securement assembly applies a sufficient compressive force on the clasping mechanism: (i) a positive angle is formed between a rear extent of the top wall of the clasping mechanism and a substantially vertical wall of the battery post, and (ii) a negative angle is formed between a rear extent of the bottom wall of the clasping mechanism and the substantially vertical wall of the battery post.

4. The battery terminal clamp assembly of claim 1, wherein in an installed state: (i) the battery post is positioned in the upper and lower battery post apertures, (ii) a securement assembly applies a sufficient compressive force on the clasping mechanism, and (iii) the top wall of the clasping mechanism is not substantially parallel with the bottom wall of the clasping mechanism.

5. The battery terminal clamp assembly of claim 1, wherein in a first partially installed state: (i) the battery post is positioned in the upper and lower battery post apertures, (ii) a securement assembly applies less than a nominal force on the clasping mechanism, and (iii) an inner surface of the top wall of the clasping mechanism is positioned a first distance from an upper surface of the bottom wall of the clasping mechanism; and
wherein in an installed state: (a) the battery post is positioned in the upper and lower battery post apertures, (b) the securement assembly applies a sufficient compressive force on the clasping mechanism, and (c) the inner surface of the top wall of the clasping mechanism is positioned a second distance from the upper surface of the bottom wall of the clasping mechanism, the second distance being greater than the first distance.

6. The battery terminal clamp assembly of claim 1, further comprising a securement assembly that is in direct contact with the top wall, and wherein said securement assembly is not in direct contact with the front wall.

7. The battery terminal clamp assembly of claim 2, wherein the securement assembly is configured to reduce the width of the continuous slit when the securement assembly moves from a untightened state S_{UT} to a tightened state S_{T}.

8. The battery terminal clamp assembly of claim 1, wherein the clasping mechanism further includes: (a) a top left side wall having a top left lower edge, and a top right side wall having a top right lower edge, and (b) a bottom left side wall having a bottom left lower edge, and a bottom right side wall having a bottom right lower edge; and
wherein when the clasping mechanism is outlined on a blank in an unfolded state prior to formation of the battery terminal clamp assembly, the upper battery post aperture is aligned with the lower battery post aperture, the top left lower edge is not aligned with the bottom left lower edge, and the top right lower edge is not aligned with the bottom right lower edge.

9. The battery terminal clamp assembly of claim 1, wherein the clasping mechanism omits a side wall that is integrally formed with both the top and bottom walls.

10. The battery terminal clamp assembly of claim 1, wherein the clasping mechanism is formed by: (a) bending the top wall around a top bend line to be substantially parallel with the front wall, and (b) bending the bottom wall around a bottom bend line to be substantially parallel with the front wall, wherein the top and bottom bend lines are parallel with one another.

11. The battery terminal clamp assembly of claim 1, wherein the upper and lower slits have two extents with curvilinear configurations, and a third extent with a linear configuration.

12. The battery terminal clamp assembly of claim 1, wherein the top wall includes a left side wall with a rear surface, and wherein said rear surface is not positioned rearward of the rearmost extent of the upper battery post aperture.

13. The battery terminal clamp assembly of claim 1, wherein the continuous slit is reflected about horizontal central axis A_{C} and mirrored about vertical axis A₁.

14. The battery terminal clamp assembly of claim 1, wherein the continuous slit does not extend to an external edge of the clasping mechanism.

15. The battery terminal clamp assembly of claim 1, wherein the front slit traverses a substantial width of the front wall.

16. The battery terminal clamp assembly of claim 1, wherein the battery terminal clamp assembly meets applicable USCAR specifications and has a pull-off force that is greater than 3,000 Newtons.

17.-79. (canceled)

80. The battery terminal clamp assembly of claim 2, wherein the securement assembly comprises:
an upper pull bar comprising an outer flange and a body including an angled portion;
a lower pull bar comprising an outer flange and a body including an angled portion; and
an elongated coupler.

81. The battery terminal clamp assembly of claim 80, wherein the body of the upper pull bar defines an oblong opening, and the body of the lower pull bar defines a threaded opening, wherein the elongated coupler (i) extends through an opening in the top wall of the clasping mechanism, (ii) extends through the oblong opening of the upper pull bar, and (iii) engages with the threaded opening of the lower pull bar.

82. The battery terminal clamp assembly of claim 81, wherein the threaded opening is thermoformed.

83. The battery terminal clamp assembly of claim 80, wherein, in a tightened state, (i) the angled portion of the upper pull bar engages with the angled portion of the lower pull bar, and (ii) the outer flange of the upper pull bar and the outer flange of the lower pull bar apply a compression force on the clasping mechanism.
